(19) United States
(12) Patent Application Publication
(10) Pub. No.: US 2017/0001426 A1
(43) Pub. Date: Jan. 5, 2017

(54) METHOD AND APPARATUS OF 3D LAMINATION

(71) Applicant: Arthur Swanberg, Lexington, KY (US)

(72) Inventor: Arthur Swanberg, Lexington, KY (US)

(21) Appl. No.: 15/202,281

(22) Filed: Jul. 5, 2016

Related U.S. Application Data
(60) Provisional application No. 62/188,407, filed on Jul. 2, 2015.

(51) Int. Cl. B32B 37/10; B32B 29/00; B32B 37/12

(52) U.S. Cl. CPC B32B 37/1018; B32B 37/12; B32B 29/002; B32B 2274/00

(57) ABSTRACT

A small, desktop lamination device is disclosed. This lamination device includes a heater that heats a thin, flexible sheet of clear, thermoplastic film; a box or container containing small holes forming a vacuum table and a central cavity connected to a vacuum source; and a piece of paper covered with an adhesive applied using a spray mechanism. When combined, these components allow the thermoplastic film to form around the three dimensional object and adhere to the paper in a process known as 3D Lamination.

### RELATED APPLICATIONS

This application claims priority to U.S. Provisional Application Ser. No. 62/188,407 filed Jul. 2, 2015 entitled Method of 3D Lamination, which is hereby incorporated herein by reference in its entirety.

### BACKGROUND OF THE INVENTION

The process of laminating paper is well documented in the art. The typical process is that a sheet of plastic, typically melamine, is placed on one or both sides of a sheet of paper. The combined plastic film and paper sheet is fed into a roll press that applies heat and pressure, which bond the plastic to the paper. This process protects the paper from the elements, thereby making it more durable and long lasting, while also allowing anything printed on the paper to be viewable. The current process for laminating plastic to paper only allows flat sheets of paper, and the finished product is a flat sheet of plastic attached to a flat sheet of paper.

In addition, the process of skin packaging is also well documented in the arts. This processes requires large, offset printing presses to apply ink that is absorbed into the paper. A heat-activated adhesive material is then applied to the reels of paper immediately following the printing process, using industrial equipment designed for long, continuous-run printing processes.

During the actual packaging, the printed sheet is set on an industrial machine containing a heating unit and vacuum source. The printed-paper is placed on a surface above the vacuum with said surface having small holes to allow the vacuum to absorb through the paper. The product to be packaged is placed on the paper. A thin piece of clear, flexible plastic or plastic-like film is heated and then placed over the product and paper, and the vacuum is engaged, drawing the heated film around the product and down to the paper, where it activates the adhesive. The activated adhesive allows the film to bond to the paper thereby holding the product to the paper where it is both visible and protected.

This process requires large, expensive, industrial machinery for printing; large, expensive, industrial machinery for applying adhesive; and large, expensive, industrial machinery for applying the plastic film. Hence, the process is suitable for large-scale production only, due to the cost of the machinery and the significant startup time required to prepare the equipment for each production run. In addition, the heat-activated adhesive used in traditionally skin packaging is specifically designed for offset printing, where the ink is absorbed into the paper, so the adhesive can form a strong bond between the thermoplastic film and the paper. This process is not recommended for digital printing where the ink rests on top of the paper and prevents the adhesive from bonding to the paper.

### SUMMARY OF THE INVENTION

A small, desktop lamination device is disclosed. This lamination device includes a heater that heats a thin, flexible sheet of clear, thermoplastic film; a box or container containing small holes forming a vacuum table (also referred to as a platent area) and a central cavity connected to a vacuum source; and a piece of paper covered with an adhesive applied using a spray mechanism. When combined, these components allow the thermoplastic film to form around the three dimensional object and adhere to the paper in a process known as 3D Lamination.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which:

FIG. 1 illustrates a side view of a piece of paper with heat-sensitive adhesive applied using a spray apparatus according to various embodiments of the invention.

FIG. 2 illustrates a side view of the heating of the thermoplastic, the adhesive-coated paper placed on a box connected to a vacuum source and a three dimensional object placed on the adhesive coated paper according to various embodiments of the invention.

FIG. 3 illustrates a side view of the heated thermoplastic film forming around the three-dimensional object and bonding to the paper with the heat-activated adhesive according to various embodiments of the invention.

FIG. 4 illustrates a side view of a rigid shell placed over a three-dimensional object and the heat-coated paper, and the heated thermoplastic film forming around the rigid shell and bonding to the paper according to various embodiments of the invention.

FIG. 5 illustrates a perspective view of one embodiment of the small unit measuring 15 inches wide, 23 inches deep and 16 inches high. The unit contains two side panels holding a heating element, a vacuum table and a frame consisting of an upper and lower frame. The thermoplastic film is placed between the upper and lower frames and the combined frame is rotated up for heating and rotated down for the vacuum process.

FIG. 6 illustrates another view of the present invention.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

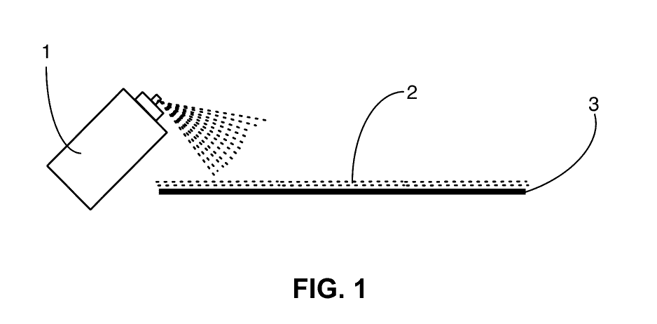

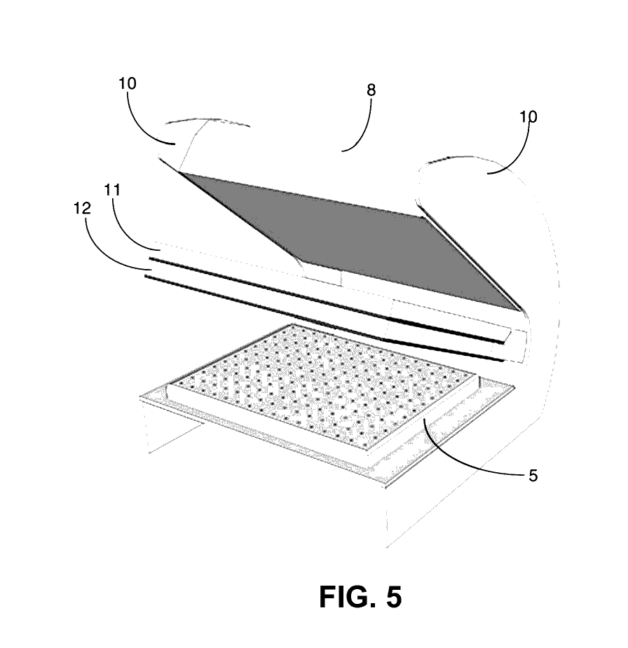

As seen in FIGS. 1-5, various embodiments of the invention include a small, desktop device (such as that seen in FIG. 5) that heats a thin, flexible sheet of clear, thermoplastic film 4; a box or container containing small holes forming a vacuum table 5 and a central cavity connected to a vacuum source 7; and a piece of paper 3 covered with an adhesive applied using a spray mechanism 1. When combined, these components allow the thermoplastic film 4 to form around the three dimensional object 6 and adhere to the paper 3 in a process known as 3D Lamination.

More specifically, a three dimensional object 6 is placed or positioned on top of the adhesive-sprayed paper 3 at a desired location that the object 6 is to be fixed or laminated to. The thermoplastic 4 is heated via the heat source 8 and applied by activating the vacuum mechanism 7 in the cavity of the device or container. The thermoplastic film will form itself around the three dimensional object 6 and activate the adhesive 3, bonding the thermoplastic film 4 to the paper, holding the object 6 in place while still allowing the object 6 to be viewable.

According to specific embodiments of the invention, the adhesive 2 is applied to the paper using a spray mechanism 1, which allows the adhesive to be applied over any paper 3, independent of the printing process, thereby allowing individuals to easily print paper using a common, digital printer, and apply the spray adhesive and laminate 3 to the paper to laminate the object 6 using a desktop, three dimensional laminator (e.g., FIG. 5).

According to one embodiment, the adhesive 2 is delivered through a spray mechanism 1 comprising a liquid adhesive material, an aerosol accelerant, a container to hold the adhesive and aerosol, and a spray mechanism to draw the aerosol accelerant and adhesive from the container and spray on the paper.

According to specific embodiments of the invention, the thermoplastic film 4 is made from Dupont™ Surlyn®. Known for its outstanding clarity, toughness, and light weight, DuPont™ Surlyn® ionomer resin is a reliable, cost-effective solution for a range of innovative packaging and other applications.

According to specific embodiments of the invention, a thermoplastic film 4 with adhesive coating pre-applied can also be used. One example of such a film is Plaskin Skin Film, a Polyolefin (polyethylene) based film used in skin packaging. It has superior adhesion characteristics and excellent durability. Since it has an adhesive applied to it, the film can stick to untreated mediums.

According to various embodiments of the invention, only a small amount of vacuum pressure is needed to create the bond between the thermoplastic film 4 and the paper 3. The necessary vacuum pressure can be as little as 3 Hg-5 Hg (Hg is inches of mercury), which is easily produced by a standard, home vacuum cleaner or shop vacuum with a 3.5 horsepower motor or higher.

In various embodiments of the invention, the heat-activated adhesive material 2 used to bond the thermoplastic film 4 to paper 3 is packaged in an aerosol can 1, thereby allowing an individual user to spray the adhesive 2 on any printed or non-printed paper and laminate three-dimensional objects 6 to the paper 3. Spraying adhesive 2 allows the user to vary the amount of adhesive 2 used to bond the thermoplastic film 4 to the paper 3. An example is when ink covers only a small portion of the paper area; only a small amount of adhesive 2 is needed to bond the thermoplastic film 4 to the paper 3. When the ink covers a large area of the paper 3, a heavier concentration of adhesive 2 may be required to penetrate the ink and reach the paper 3, allowing strong adhesion.

According to specific embodiments of the invention, the heat-activated adhesive 2 sprayed on the paper is LOCTITE LIOFOL HS B7089ANS made by Henkel Corporation. LOCTITE LIOFOL HS B7089ANS is an aqueous heat seal coating on paperboard for use in skin packaging applications utilizing Surlyn and polyethylene film.

According to specific embodiments of the invention, the heat-activated adhesive 2 sprayed on the paper is Aquaseal™ 2101 made by Paramelt Corporation. Aquaseal™ 2101 is a solvent free dispersion of polymers, waxes and resins. Designed to give good adhesion and heat-sealing against a range of substrates including PP, PE, PS, PET, PVC, paper and foil. Applied in IML/skin/blister packaging, shrink sleeves and other heat seal markets.

In various embodiments of the invention, the heat-activated adhesive material 2 used to bond thermoplastic film to paper is packaged in a pump spray, thereby allowing an individual user to spray the adhesive on any printed or non-printed paper and laminate three-dimensional objects to paper.

In various embodiments of the invention the heat-activated adhesive material 2 used to bond thermoplastic film to paper 3 is applied using a hand roller, allowing individual users to coat any printed or non-printed paper with the adhesive and laminate three-dimensional objects to paper.

In various embodiments of the invention a rigid, a three dimensional shell 9 made of plastic, paper, or various other materials, is applied over the product 6 on the paper 3, prior to applying the heated flexible thermoplastic film 4. When the flexible thermoplastic 4 is applied over the rigid shell 9 and paper 3 using a vacuum source 7, the film 4 attaches to the rigid shell 9 and the paper 3 so the rigid shell 9 is held tightly to the paper 3 and any object 6 inside the rigid shell 9 is protected from the elements.

In various embodiments of the invention, the thermoplastic film 4 is coated with adhesive 2 and adhesive 2 is applied to the paper 3. When digitally printed-paper is used, which does not absorb the digital ink, the double layer of adhesive 2 on the plastic 4 and on the paper 3 will form a stronger bond between the thermoplastic film 4 and the paper 3.

In various embodiments of the invention, the paper 3 itself is three dimensional, such as a box top, and adhesive 2 is applied to the paper 3, allowing the heated thermoplastic film 4 to form around the three-dimensional paper object 3 and adhere to it using a vacuum source 7.

In various embodiments of the invention, the paper 3 is part of a book, such as a 3-ring binder used for scrapbooking. The paper 3 is printed with various words and images and the adhesive spray 2 is applied. Objects such as mementos are placed on the printed sheet 3 prior to applying the heated, thermoplastic film 4. When the clear, thermoplastic film 4 is applied using the vacuum source 7, the mementos are held in place on the paper 3. Holes can be punched in the paper 3, allowing it to be inserted in a book or binder.

FIG. 1 illustrates one embodiment of the invention in which the spray apparatus containing the adhesive 1 is used to apply the adhesive 2 onto the paper 3. As described above, the adhesive can be applied to the entire paper 3, or only a portion of the paper 3. The adhesive e can either be applied after the paper 3 is placed in the thee-dimensional laminator machine (FIG. 5) or prior to being placed in the machine.

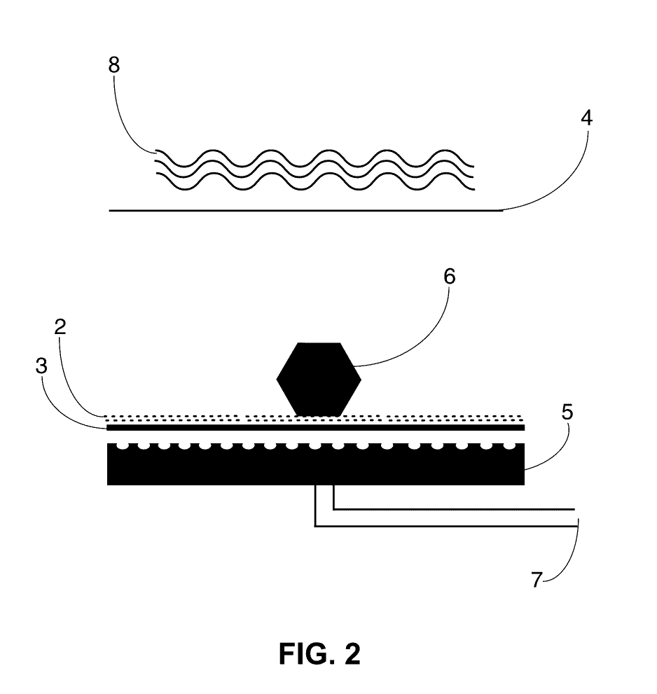

Referring to FIG. 2, the thermoplastic 4 is placed in the laminator machine between the upper frame 11 and the lower frame 12 as discussed later with regard to FIG. 5, then heated using a heating source 8 that is located on an upper portion of the laminator machine. While the thermoplastic 4 is heating, the paper 3 containing the adhesive 2 is placed on the vacuum table 5 (if it is not already located there), which is connected to a vacuum source 7. A three dimensional object 6 is placed on the paper 3.

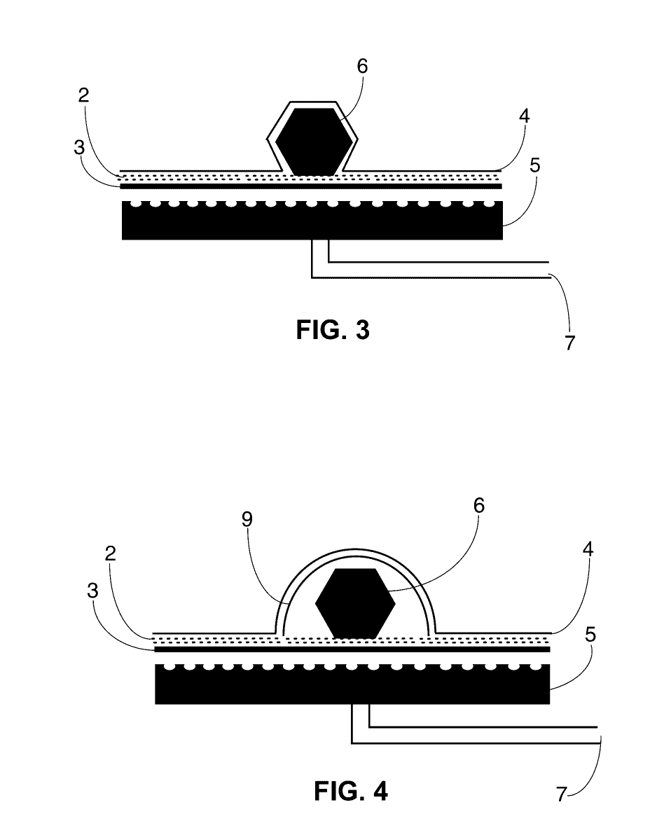

In FIG. 3. the vacuum source 7 is activated, creating a vacuum in box 5. The frames 11 and 12 are moved downward towards the vacuum box 5, allowing the vacuum force to draw the heated thermoplastic 4 around the three-dimensional object 6 and to bond to the paper 3 using the heat-activated adhesive 2.

FIG. 4 illustrates a similar process in which a rigid shell 9 is placed over the three-dimensional object 6 prior to applying the film 4. The vacuum source 7 is engaged creating a vacuum in box 5. The vacuum draws the heated thermoplastic 4 around the rigid shell 9 where it bonds to the paper 3 using the heat-activated adhesive 2.

FIG. 5 illustrates one embodiment of the 3D Laminator of the present invention. The laminator consists of two side panels 10 (or frame members), which support the heating source 8, the vacuum table 5, the upper frame 11, and the lower frame 12. Preferably, the vacuum table 5 is supported in a relatively flat or level position when the laminator is located on a flat surface. The heating source 8 is fixed above the vacuum table 5 and at an angle relative to the vacuum table 5, such as within the range of 0 and 90 degrees. For example, the heating source 8 may be generally parallel to the table 5 (i.e., 0 degrees) or may be angled at about 45 degrees. While the side panels 10 are illustrated as maintaining the heating source 8 in a fixed position relative to the vacuum table 5, it should be noted that the heating source 8 may be pivotally connected to a portion of the side panels 10, allowing it to selectively pivot during operation. Preferably, the heating source 8 is composed of a plurality of electrical heating elements that are evenly located between both side panels 10.

During the 3D Lamination process, the thermoplastic film is placed between the upper frame 11 and lower frame 12. The combined frame unit is rotated 40 degrees to the heating source 8. The lower frame 12 has a generally square or rectangular shape (though other shapes, such as a circle, are also possible), and is pivotally connected to the side panels 10 so as to move the lower frame 12 either near the heating source 8 or near the vacuum table 5. The upper frame 11 is located on a top portion of the lower frame 12 and generally has the same shape as the lower frame 12. The upper frame 11 preferably is pivotally connected to the lower frame 12 or is fully removable/engagable with the lower frame 12, so as to allow the film 4 to be easily place between the frames 11, 12 during operation. The frames 11, 12 are generally composed of outer frame members forming a large space between them through which the film 4 can be accessed by either the heat source 8 or the vacuum table 5.

After a heating period of, for example, 20 seconds or more, the frame units 11, 12 are rotated down to the vacuum table 5, where vacuum is applied to the paper 3 and film 4. After the vacuum process is completed (5-15 seconds), upper frame 11 is lifted and the combined film, paper and product are removed.

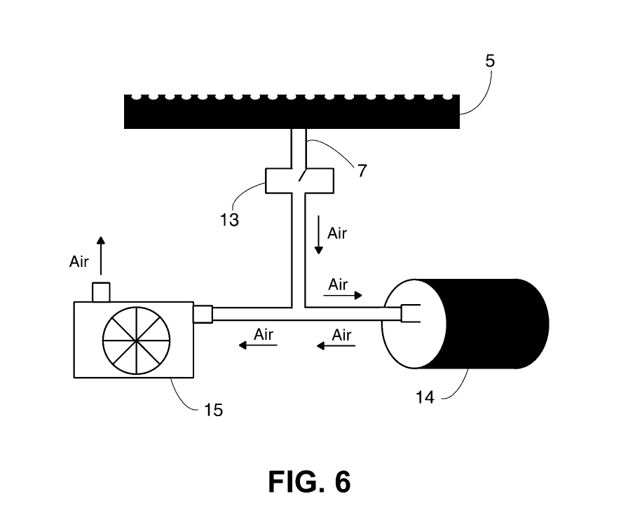

FIG. 6 illustrates one embodiment of the invention. The vacuum source 7 is connected to a normally closed valve 13. The valve is connected to a surge tank 14 and a vacuum pump 15. When the vacuum pump 15 is powered ON and the valve 13 is closed, airflows from the surge tank 14 to the vacuum pump 15, forming a reserve vacuum source in the surge tank 14. When the valve 13 is opened manually or through electrical current, air from the vacuum table 5 moves rapidly to fill the vacuum area in surge tank 14. After vacuum process is complete, the valve 13 is closed, allowing air in the surge tank 14 to again flow to the vacuum pump 15, allowing the surge tank 14 to again form a reserve vacuum source.

In another embodiment according to the present invention, the prior described device may be used with a vinyl sheet containing printed words or images and applied over a 3D object, such as a wooden or wood-like plaque.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A process to laminate three-dimensional objects to paper comprising:
a desktop device containing a heating element and a vacuum source; and
a clear, thermoplastic film; and
a printed or non-printed piece of paper with heat-activated adhesive applied via a spray source, where the heating element heats the thermoplastic film and the film is applied over the three dimensional object placed on the paper and the vacuum source pulls the thermoplastic film to the paper where it bonds to the paper holding the object in place.

2. A process to apply the heat-activated adhesive on the paper using a spray mechanism, consisting of:
a liquid adhesive material;
an aerosol accelerant;
a container to hold the combined elements; and
a spray system to draw the elements from the container and spray it on the paper

3. A process to laminate three-dimensional objects to digitally-printed paper comprising:
a desktop device containing a heating element and a vacuum source; and
a clear, thermoplastic film with heat-activated adhesive coating; and
a digitally-printed piece of paper with heat-activated adhesive applied via a spray source, where the heating element heats the thermoplastic film and the film is applied over the three dimensional object placed on the paper and the vacuum source pulls the thermoplastic film to the paper where it bonds to the paper holding the object in place.

4.-8. (canceled)
